(19) United States
(12) Patent Application Publication
(10) Pub. No.: US 2007/0283964 A1
(43) Pub. Date: Dec. 13, 2007

(54) Reusable exhalation valve & mouthpiece for use with filtering face mask

(76) Inventor: William Gorman, South Hamilton, MA (US)

Correspondence Address: William J. Gorman, 62 Lakeshore Drive, South Hamilton, MA, 01982, US

(21) Appl. No.: 11/805,353

(22) Filed: May 23, 2007

Related U.S. Application Data
(60) Provisional application No. 60/808,215, filed on May 25, 2006.

(51) Int. Cl. A62B 18/02; A62B 18/08; A62B 18/10

(52) U.S. Cl. 128/206.29; 128/206.21; 128/207.12

(57) ABSTRACT

A reusable device that can be attached to any filtering face mask to provide an exhalation valve and a mouthpiece to direct the exhaled air out of the mask, thereby reducing the heat and moisture inside the mask. This device may include a filter to clean the exhaled air for use in areas where directly exhaled air is disadvantageous such as operating rooms and clean manufacturing environments. This device may also include a cutting means that make it easy to attach the device to a mask by aiding in perforating the mask. This device may include various attachment means to secure the device to the mask such as threaded attachments, snap attachments, tapered attachments and adhesive attachments. This device may also include the use of soft materials for the mouthpiece to make the device conformable, comfortable and to minimize trauma in the case of a sudden unexpected impact to the mask. This device may be cleaned and sterilized for reuse. The reusability of the device reduces the cost of the filtering mask. This device may be configured to include a standard one-way valve as available on masks today with an added mouthpiece to direct exhaled air to the outside. This mouthpiece can be removably attached so that it might be transferred to another mask thereby saving cost.

### BACKGROUND

This invention relates to respirators of the type usually known as dust masks, such respirators sometimes include a filter of fibrous material for trapping and holding particulate matter in the form of dust or fume, or aerosols in the form of mist suspended in air that passes through the filter. Another use for such devices is to contain contaminants from being exhaled into a controlled environment such as an operating room or a clean manufacturing area.

In their simplest form, such respirators are comprised of a face piece formed from stabilized textile fibers, and which has been appropriately molded or otherwise formed for it to extend over the nose and mouth of a user, and, which is held in that position by elastic straps attached to the face piece and which are passed over the user's head to resiliently hold the respirator in situ over the user's nose and mouth.

Such dust masks are entirely temporary and fully disposable, in that once the filtering capability of the filter has been exhausted due to clogging of the filter or exhaled moisture, the user discards the dust mask and replaces it with another, unused mask.

There are several types of single use masks used for various types of employment including cloth surgical masks, smog masks, pollen reduction masks to name a few.

These masks all impede inhalation by the user as particulate matter and moisture build up in the filter, such masks also progressively impede exhalation by the user through the clogged filter material, unless some form of exhalation valve is provided, as taught in U.S. Pat. No. 4,454,881, Huber et al. In the absence of an exhalation valve, a further physical stress is imposed on the user, particularly in the event that the user is involved in manually strenuous work. Further, such respirators or dust masks have a relatively large internal volume that becomes filled with exhaled air as the user exhales, and which is then reinhaled when the user next inhales. Heat and moisture from the inhaled air raises temperature of the thick (extra thick in case of metal fume) filter fibers from exhalation. This heat is then transferred to the incoming air upon inhalation. A raise in temperature as low as 2°-3° causes great psychological and physical discomfort to the user.

An alternative approach to such respirators is disclosed in U.S. Pat. No. Des., 270,957, Maryyanek, which provides a face piece of soft rubber-like material, to which is attached a replaceable air filter in the form of a cartridge that snaps onto an inlet of the face piece controlled by a conventional inlet valve. The face piece is separately provided with dual conventional exhalation valves attached to the face piece at positions spaced from the inlet valve, and which are actuated by the rise in pressure in the face piece upon exhalation by the user.

In this construction, air inhaled through the filter does not have to be subsequently exhaled through the filter, but instead, is by-passed through the exhalation valves.

While this construction is successful in retaining disposability and replacement of the filter cartridge, it carries with it the disadvantage in this construction, the face piece and its associated exhalation valves present a relatively large internal volume within the face piece in which exhaled air is trapped, and, subsequently is re-inhaled by the user.

Replacement filter respirators of this latter type are referred to as semi-disposable respirators, in that the cartridge incorporating the filter material can be removed from the face piece for disposal and replacement by an unused cartridge, the face piece itself and its associated inhalation and exhalation valves being a permanently retained portion of the respirator.

### BRIEF DESCRIPTION OF THE FIGURES

FIG. 1 is a side view of the device installed in a standard dust mask.

FIG. 2 is a side view of another embodiment of the device installed in a standard dust mask.

FIG. 3 is a side view of another embodiment of the device installed in a standard dust mask.

FIG. 4 is a side view of another embodiment of the device disassembled to show internal details.

### DETAILED DESCRIPTION OF PREFERRED EMBODIMENTS

For the purposes of promoting an understanding of the principles of the invention, reference will be made to the embodiments illustrated in the drawings and specific language will be used to describe the same. It will nevertheless be understood that no limitation of the scope of the invention is herby intended. Any such alterations further modifications in the illustrated devices, any such further applications of the principles of the invention as illustrated herein are contemplated as would normally occur to one skilled in the at to which the invention relates.

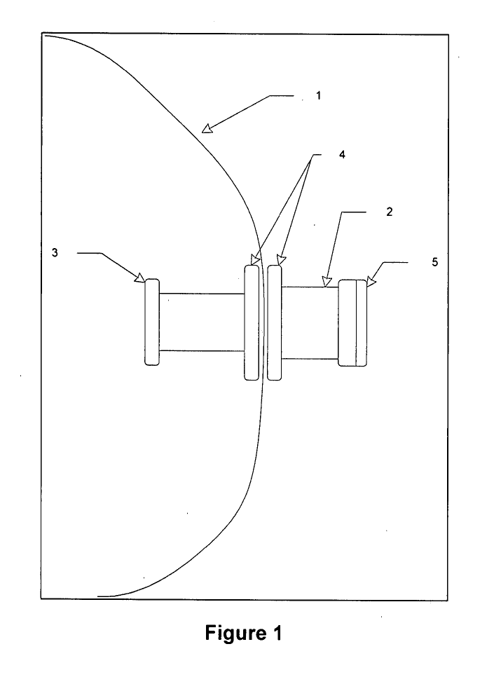

FIG. 1 depicts an embodiment of the device that has been attached to a mask 1. This device includes a body 2, internal and external flanges 4, a one way valve 5, and a mouthpiece 3.

In this configuration the device has been attached through a perforation in the mask and flanges 4, retain the seal between the mask 1, and the device. The device is supplied in two sections that are joined to capture the mask between the flanges 4.

It is noted that some masks are commercially available with the external component 2, flanges 4, and valve 5 preinstalled. One embodiment of this device includes a mouthpiece 3 that can be mated to a preinstalled valve assembly commercially available on masks today.

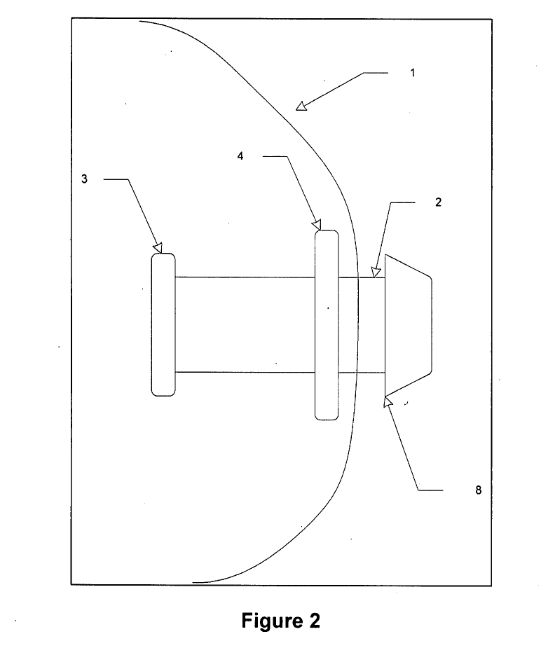

FIG. 2 depicts an embodiment of the device that has been attached to a mask 1. This device includes a body 2, an external barb 8, an internal flange 4, a one way valve 5, and a mouthpiece 3.

In this configuration the device has been attached through a perforation in the mask. Barb 8 retains the seal between the mask 1, and the device body 2.

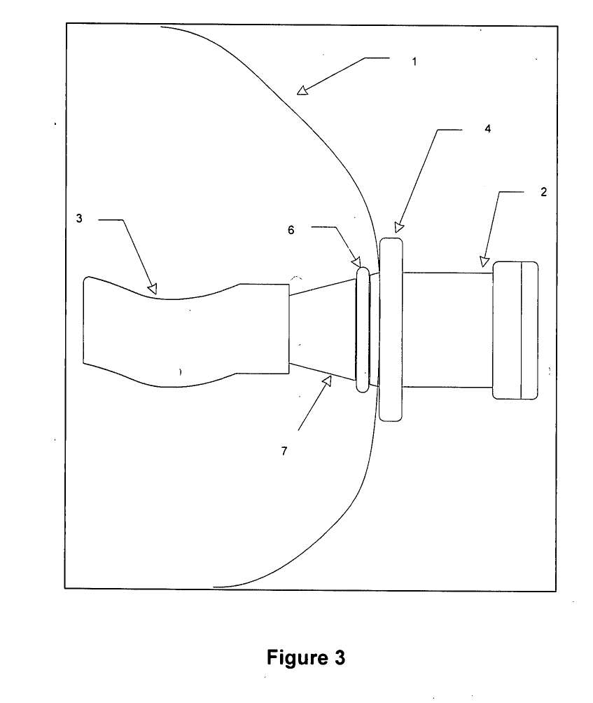

FIG. 3 depicts an embodiment of the device that has been attached to a mask 1. This device includes a body 2, a flange 4, a one way valve 5, a flexible mouthpiece 3, a taper 7, and a retaining ring 6.

In this embodiment a seal is formed to the mask utilizing the flange 4, the taper 7, and the retaining ring 6. In this embodiment the device can be removed by removing the retaining ring.

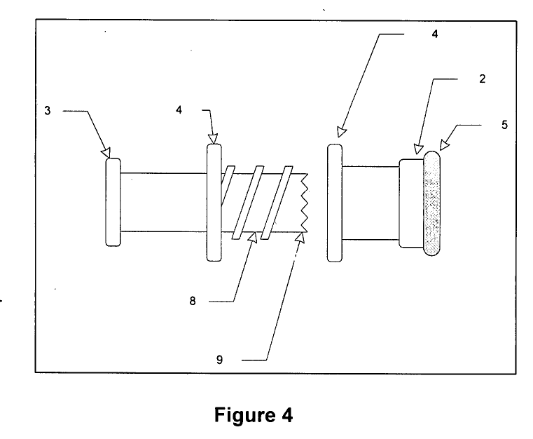

FIG. 4 depicts an embodiment of the device that has been dissessembled. This device includes a body 2, internal and external flanges 4, a one way valve 5, a mouthpiece 3, a threaded diameter 8, and a cutting means 9.

In this embodiment the device cuts a perforation into the mask during assembly using cutting means 9. The mask is captured and a seal is formed with the mask utilizing the flanges 4, when the device is screwed together using threaded diameter 8.

### SUMMARY OF THE INVENTION

It is an object of this invention to retain to the greatest possible extent the advantages of lightness, and enhanced area of filtration surfaces such are found in known disposable respirators and masks, while eliminating the disadvantages thereof without adding cost to these masks.

This is accomplished according to the present invention by providing a reusable device that can be attached to any mask to provide an exhalation valve and a mouthpiece to direct the exhaled air out of the mask, thereby reducing the heat and moisture inside the mask.

A further embodiment includes a filter to clean the exhaled air for use in areas where directly exhaled air is disadvantageous such as operating rooms and clean manufacturing environments.

A further embodiment includes a cutting means that make it easy to attach the device to a mask by aiding in perforating the mask.

Further embodiments are various attachment means to secure the device to the mask such as threaded attachments, snap together attachments, tapered attachments and adhesive attachments.

Further embodiments include the use of soft materials for the mouthpiece to make the device conformable, comfortable and to minimize trauma in the case of a sudden unexpected impact to the mask.

A further embodiment includes the use of materials that allow the device to be cleaned and sterilized for reuse.

A further embodiment includes a diverter to divert the exhaled air down or to the side to avoid exhaled air for contaminating or otherwise compromising the work area in front of the mask. This diverter could include a long tube to allow significant redirection of exhaled air and moisture.

A further embodiment includes both inlet and outlet valves. In this embodiment the inlet valve takes inhaled air from the inside of the mask and the outlet valve directs exhaled air to the outside of the mask.

Further embodiments include multiple piece designs that allow assembly and disassembly to accomplish attachment to the mask, cleaning and changing of the filter elements or valve components.

Further embodiments include the ability to pre-attach the mouthpiece to the mask to make it more convenient and useful in an emergency scenario.

Further embodiments include the ability to pre-attach the mouthpiece to a mask that already has a one-way valve installed.

Further embodiments include providing the one-way valve as available on masks today with an added mouthpiece to direct exhaled air to the outside. This mouthpiece can be removably attached so that it might be transferred to another mask thereby saving cost.

It is understood that other embodiments can be fabricated and come within the spirit and scope of these claims.

We claim:

1. A device with a mouthpiece and a one-way valve for attachment to a mask configured to direct exhaled air to the outside of the mask.

2. A device as in claim 1 including: a body segment, a one-way valve attached to the body segment and at least one flange attached to the body segment.

3. A device as in claim 1 that is composed of two pieces that are joined during attachment to the mask.

4. A device as in claim 1 where the mouthpiece is flexible.

5. A device as in claim 1 that includes an inhalation valve.

6. A device as in claim 1 that includes a filter to clean the exhaled air.

7. A device as in claim 1 that is reusable and is made of materials that can withstand cleaning.

8. A device as in claim 1 that includes an attachment means to secure the device to a perforation in a mask where said attachment means includes one of: retaining ring, threaded diameter, snap feature, pressure sensitive adhesive, tapered diameter or barb.

9. A device as in claim 8 that includes a cutting means to perforate the mask to facilitate attachment of the device.

10. A device with a mouthpiece including means for attachment to a one-way valve configured to direct exhaled air to the outside of a mask where the one-way valve is preattached to the mask.

11. A device as in claim 10 where the mouthpiece is flexible.

12. A device with a mouthpiece and a one-way valve to direct exhaled air to the outside of a mask where said device is preattached to a mask.

13. A device as described in the figures in this document.

14. A device as described in the text of this document.
